(19) United States
(12) Patent Application Publication
(10) Pub. No.: US 2008/0172348 A1
(43) Pub. Date: Jul. 17, 2008

(54) Statistical Determination of Multi-Dimensional Targets

(75) Inventors: Ian Tien, Seattle, WA (US); Corey Hulen, Sammamish, WA (US); Chen-I Lim, Bellevue, WA (US); Catalin Tomai, Bellevue, WA (US)

Correspondence Address: MERCHANT & GOULD (MICROSOFT), P.O. BOX 2903, MINNEAPOLIS, MN, 55402-0903, US

(73) Assignee: Microsoft Corporation, Redmond, WA (US)

(21) Appl. No.: 11/623,953

(22) Filed: Jan. 17, 2007

(51) Int. Cl. G06F 15/18; G06N 5/02; G06Q 10/00

(52) U.S. Cl. 706/12; 706/15; 706/47; 705/7

(57) ABSTRACT

Users are enabled to use statistical prediction algorithms to set key performance indicator targets based on a variety of considerations allowing them to take into account more quantitative factors in prediction, increase return-on-investment of data assets, increase consistency, and save time and cost in the target setting process. Upon selection of a scorecard, users are provided with a series of user interfaces enabling them to select metrics and data ranges, as well as to set and/or modify configurations associated with prediction algorithms for the selected data and report presentation parameters. Data mining may then be performed based on the selected data and configuration settings resulting in rendering of reports based on the data mining result set(s).

### BACKGROUND

Key Performance Indicators (KPIs) are quantifiable measurements that reflect the critical success factors of an organization ranging from income that comes from return customers to percentage of customer calls answered in the first minute. Key Performance Indicators may also be used to measure performance in other types of organizations such as schools, social service organizations, and the like. Measures employed as KPI within an organization may include a variety of types such as revenue in currency, growth or decrease of a measure in percentage, actual values of a measurable quantity, and the like.

Business users often need to set targets across broad sets of key performance indicators, data that has the potential to be indicative of the strategic performance of an organization. However, the sheer number of factors they take into account multiplied by the high volume of decisions to be made makes manual predications expensive from a time and resource perspective. Organizations typically aim to set goals without the use of resource-expensive decisions, considerable investments in analysis and data warehousing tools, or hiring of substantial number of analysts to work long hours analyzing large amounts of data to set detailed targets manually. Moreover, the involvement of increased number of people, tools, and large amount of data may result in higher rates of inconsistency and error.

### SUMMARY

This summary is provided to introduce a selection of concepts in a simplified form that are further described below in the Detailed Description. This summary is not intended to identify key features or essential features of the claimed subject matter, nor is it intended as an aid in determining the scope of the claimed subject matter.

Embodiments are directed to enabling business users to employ statistical prediction algorithms to set key performance indicator targets based on a variety of considerations. Upon selection of a scorecard, users may be provided with a series of user interfaces enabling them to select metrics and data ranges, as well as to set and/or modify configurations associated with statistical analysis and report view aspects. Reports may be rendered based on results of the analysis as defined by the selections and configuration settings.

These and other features and advantages will be apparent from a reading of the following detailed description and a review of the associated drawings. It is to be understood that both the foregoing general description and the following detailed description are explanatory only and are not restrictive of aspects as claimed.

### BRIEF DESCRIPTION OF THE DRAWINGS

FIG. 1 illustrates an example scorecard architecture according to aspects;

FIG. 2 illustrates a screenshot of an example scorecard;

FIG. 3 is a screenshot of an example scorecard application with a target prediction user interface;

FIG. 4 illustrates an example user interface for defining trend analysis in a scorecard application;

FIG. 5 illustrates an example user interface for selecting a scorecard in creating trend analysis based on performance metrics;

FIG. 6 is illustrates an example user interface for row selection (metric selection) as part of trend analysis in a scorecard application;

FIG. 7 illustrates an example user interface for selecting a data range as part of trend analysis in a scorecard application;

FIG. 8 illustrates another example user interface for selecting a data range as part of trend analysis in a scorecard application;

FIG. 9 illustrates an example user interface for defining predication settings as part of trend analysis in a scorecard application;

FIG. 10 illustrates an example user interface for defining layout parameters of a trend analysis report in a scorecard application;

FIG. 11 illustrates implementation of statistical determination of multi-dimensional targets in a networked system;

FIG. 12 is a block diagram of an example computing device operating environment, where embodiments may be implemented; and

FIG. 13 illustrates a logic flow diagram for a process of statistical determination of multi-dimensional targets.

### DETAILED DESCRIPTION

As briefly described above, statistical prediction algorithms may be used to set key performance indicator targets in a scorecard-based business logic system employing a variety of considerations. In the following detailed description, references are made to the accompanying drawings that form a part hereof, and in which are shown by way of illustrations specific embodiments or examples. These aspects may be combined, other aspects may be utilized, and structural changes may be made without departing from the spirit or scope of the present disclosure. The following detailed description is therefore not to be taken in a limiting sense, and the scope of the present invention is defined by the appended claims and their equivalents.

While the embodiments will be described in the general context of program modules that execute in conjunction with an application program that runs on an operating system on a personal computer, those skilled in the art will recognize that aspects may also be implemented in combination with other program modules.

Generally, program modules include routines, programs, components, data structures, and other types of structures that perform particular tasks or implement particular abstract data types. Moreover, those skilled in the art will appreciate that embodiments may be practiced with other computer system configurations, including hand-held devices, multiprocessor systems, microprocessor-based or programmable consumer electronics, minicomputers, mainframe computers, and the like. Embodiments may also be practiced in distributed computing environments where tasks are performed by remote processing devices that are linked through a communications network. In a distributed computing environment, program modules may be located in both local and remote memory storage devices.

Embodiments may be implemented as a computer process (method), a computing system, or as an article of manufacture, such as a computer program product or computer readable media. The computer program product may be a computer storage media readable by a computer system and encoding a computer program of instructions for executing a computer process. The computer program product may also be a propagated signal on a carrier readable by a computing system and encoding a computer program of instructions for executing a computer process.

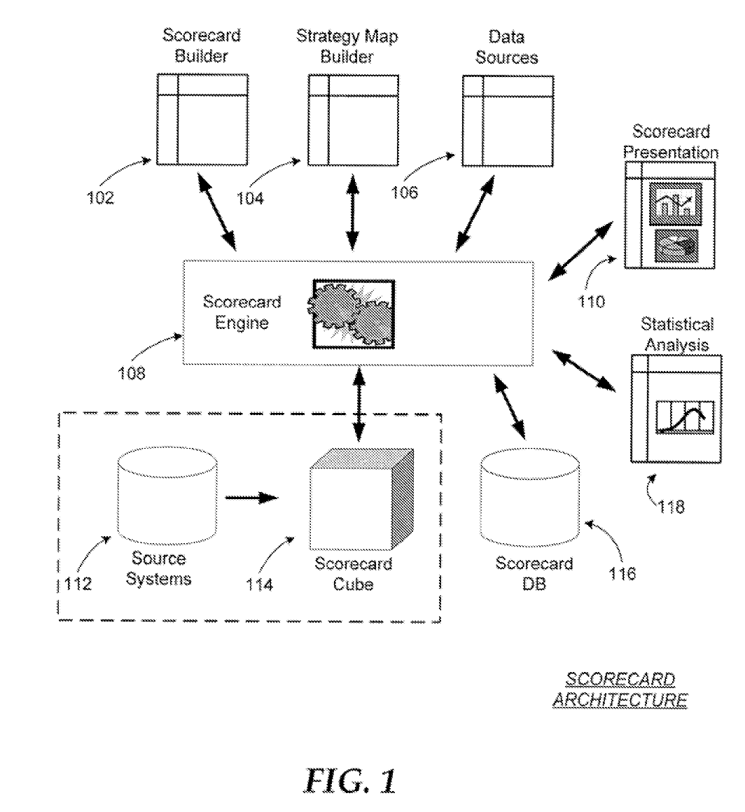

Referring to FIG. 1, an example scorecard architecture is illustrated. The scorecard architecture may comprise any topology of processing systems, storage systems, source systems, and configuration systems. The scorecard architecture may also have a static or dynamic topology.

Scorecards are an easy method of evaluating organizational performance. The performance measures may vary from financial data such as sales growth to service information such as customer complaints. In a non-business environment, student performances and teacher assessments may be another example of performance measures that can employ scorecards for evaluating organizational performance. In the exemplary scorecard architecture, a core of the system is scorecard engine 108. Scorecard engine 108 may be an application software that is arranged to evaluate performance metrics. Scorecard engine 108 may be loaded into a server, executed over a distributed network, executed in a client device, and the like.

Data for evaluating various measures may be provided by a data source. The data source may include source systems 112, which provide data to a scorecard cube 114. Source systems 112 may include multi-dimensional databases such OLAP, other databases, individual files, and the like, that provide raw data for generation of scorecards. Scorecard cube 114 is a multi-dimensional database for storing data to be used in determining Key Performance Indicators (KPIs) as well as generated scorecards themselves. As discussed above, the multi-dimensional nature of scorecard cube 114 enables storage, use, and presentation of data over multiple dimensions such as compound performance indicators for different geographic areas, organizational groups, or even for different time intervals. Scorecard cube 114 has a bi-directional interaction with scorecard engine 108 providing and receiving raw data as well as generated scorecards.

Scorecard database 116 is arranged to operate in a similar manner to scorecard cube 114. In one embodiment, scorecard database 116 may be an external database providing redundant back-up database service.

Scorecard builder 102 may be a separate application or a part of a business logic application such as the performance evaluation application, and the like. Scorecard builder 102 is employed to configure various parameters of scorecard engine 108 such as scorecard elements, default values for actuals, targets, and the like. Scorecard builder 102 may include a user interface such as a web service, a GUI, and the like.

Strategy map builder 104 is employed for a later stage in scorecard generation process. As explained below, scores for KPIs and other metrics may be presented to a user in form of a strategy map. Strategy map builder 104 may include a user interface for selecting graphical formats, indicator elements, and other graphical parameters of the presentation.

Data Sources 106 may be another source for providing raw data to scorecard engine 108. Data sources 106 may also define KPI mappings and other associated data.

Additionally, the scorecard architecture may include scorecard presentation 110. This may be an application to deploy scorecards, customize views, coordinate distribution of scorecard data, and process web-specific applications associated with the performance evaluation process. For example, scorecard presentation 110 may include a web-based printing system, an email distribution system, and the like. In some embodiments, scorecard presentation 110 may be an interface that is used as part of the scorecard engine to export data for generating presentations or other forms of scorecard-related documents in an external application. For example, metrics, reports, and other elements (e.g. commentary) may be provided with metadata to a presentation application (e.g. PowerPoint® of MICROSOFT CORPORATION of Redmond, Wash.), a word processing application, or a graphics application to generate slides, documents, images, and the like, based on the selected scorecard data.

Moreover, the scorecard architecture may include statistical analysis 118. Statistical analysis 118 may be a separate application or a module integrated into the architecture for performing statistical analysis on scorecard data such as trend prediction. A scorecard may comprise a large number of elements with complex interrelations. In some cases, it may be difficult for a subscriber to analyze the elements in various combinations or detect correlations. Data mining applications may be a useful tool in such cases determining correlative relationships between elements based on subscriber provided configurations. Statistical analysis 118 may also interact with scorecard presentation 110 enabling the subscriber to configure presentation parameters for results of the statistical analysis.

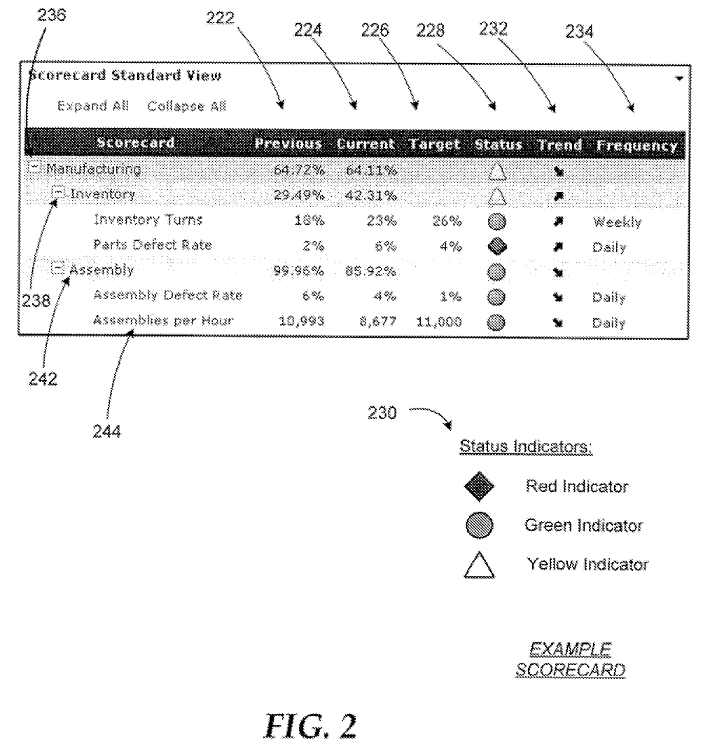

FIG. 2 illustrates a screenshot of an example scorecard with status indicators 230. As explained before, Key Performance Indicators (KPIs) are specific indicators of organizational performance that measure a current state in relation to meeting the targeted objectives. Decision makers may utilize these indicators to manage the organization more effectively.

When creating a KPI, the KPI definition may be used across several scorecards. This is useful when different scorecard managers might have a shared KPI in common. This may ensure a standard definition is used for that KPI. Despite the shared definition, each individual scorecard may utilize a different data source and data mappings for the actual KPI.

Each KPI may include a number of attributes. Some of these attributes include frequency of data, unit of measure, trend type, weight, and other attributes.

The frequency of data identifies how often the data is updated in the source database (cube). The frequency of data may include: Daily, Weekly, Monthly, Quarterly, and Annually.

The unit of measure provides an interpretation for the KPI. Some of the units of measure are: Integer, Decimal, Percent, Days, and Currency. These examples are not exhaustive, and other elements may be added without departing from the scope of the invention.

A trend type may be set according to whether an increasing trend is desirable or not. For example, increasing profit is a desirable trend, while increasing defect rates is not. The trend type may be used in determining the KPI status to display and in setting and interpreting the KPI banding boundary values. The arrows displayed in the scorecard of FIG. 2 indicate how the numbers are moving this period compared to last. If in this period the number is greater than last period, the trend is up regardless of the trend type. Possible trend types may include: Increasing Is Better, Decreasing Is Better, and On-Target Is Better.

Weight is a positive integer used to qualify the relative value of a KPI in relation to other KPIs. It is used to calculate the aggregated scorecard value. For example, if an Objective in a scorecard has two KPIs, the first KPI has a weight of 1, and the second has a weight of 3 the second KPI is essentially three times more important than the first, and this weighted relationship is part of the calculation when the KPIs' values are rolled up to derive the values of their parent metric.

Other attributes may contain pointers to custom attributes that may be created for documentation purposes or used for various other aspects of the scorecard system such as creating different views in different graphical representations of the finished scorecard. Custom attributes may be created for any scorecard element and may be extended or customized by application developers or users for use in their own applications. They may be any of a number of types including text, numbers, percentages, dates, and hyperlinks.

One of the benefits of defining a scorecard is the ability to easily quantify and visualize performance in meeting organizational strategy. By providing a status at an overall scorecard level, and for each perspective, each objective or each KPI rollup, one may quickly identify where one might be off target. By utilizing the hierarchical scorecard definition along with KPI weightings, a status value is calculated at each level of the scorecard.

First column of the scorecard shows example top level metric 236 “Manufacturing” with its reporting KPIs 238 and 242 “Inventory” and “Assembly”. Second column 222 in the scorecard shows results for each measure from a previous measurement period. Third column 224 shows results for the same measures for the current measurement period. In one embodiment, the measurement period may include a month, a quarter, a tax year, a calendar year, and the like.

Fourth column 226 includes target values for specified KPIs on the scorecard. Target values may be retrieved from a database, entered by a user, and the like. Column 228 of the scorecard shows status indicators 230.

Status indicators 230 convey the state of the KPI. An indicator may have a predetermined number of levels. A traffic light is one of the most commonly used indicators. It represents a KPI with three-levels of results—Good, Neutral, and Bad. Traffic light indicators may be colored red, yellow, or green. In addition, each colored indicator may have its own unique shape. A KPI may have one stoplight indicator visible at any given time. Other types of indicators may also be employed to provide status feedback. For example, indicators with more than three levels may appear as a bar divided into sections, or bands. Column 232 includes trend type arrows as explained above under KPI attributes. Column 234 shows another KPI attribute, frequency.

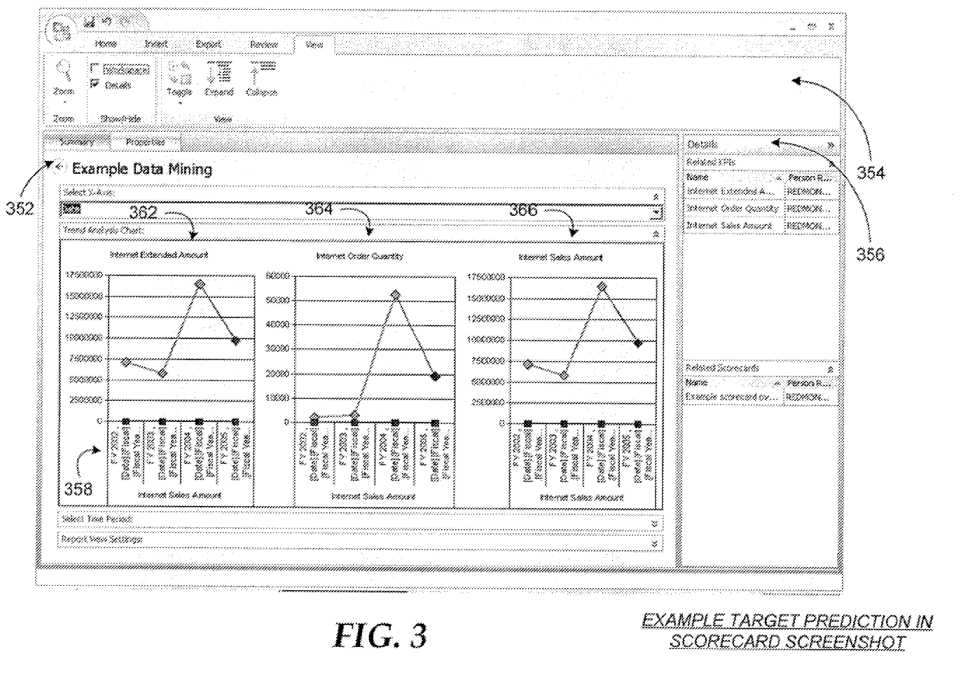

FIG. 3 is a screenshot of an example scorecard application with a target prediction user interface. The example scorecard application may be part of a business logic service that collects, processes, and analyzes performance data from various aspects of an organization.

The user interface of the scorecard application as shown in the screenshot includes controls 354 for performing actions such as formatting of data, view options, actions on the presented information, and the like. The main portion of the user interface displays a summary view of target prediction analysis based on selected scorecard elements titled “Example Data Mining”(352). As mentioned previously, the results of the statistical analysis may be provided by the scorecard application or by a separate application. Thus, exchange of data and configuration parameters in a seamless manner is a significant aspect of the interaction. The side panel “Details” 356 shows a list of related KPIs and scorecards. These may be listed by name, owner, and the like. The related KPIs and scorecards may also be listed at various detail levels such as different elements, actuals, targets, and the like.

Back on the main panel, “Example Data Mining” 352 displays charts for three different trend analysis results: Internet Extended Amount 362, Internet Order Amount 364, and Internet Sales Amount 366 enabling the subscribers to view sales trends from three different perspectives. Each chart includes data points for different fiscal periods (358) along their horizontal axes. The main panel may also include links to other phases of trend analysis presentation such as time period selection, report view settings, and the like.

The report view screen of the statistical analysis as shown in the figure may be rendered through various means such as a guided, wizard-based experience for manipulating report view properties or direct manipulation through a shell using context menus and/or toolbars, as explained below. According to some embodiments, properties common to report views (such as name, identifier and layout properties), along with pre-requisite property settings for specific report views may be provided to the subscriber using the wizard experience. Edit operations may bring up the wizard again in context. Properties that are highly visual or fine in detail may be provided using a toolbar.

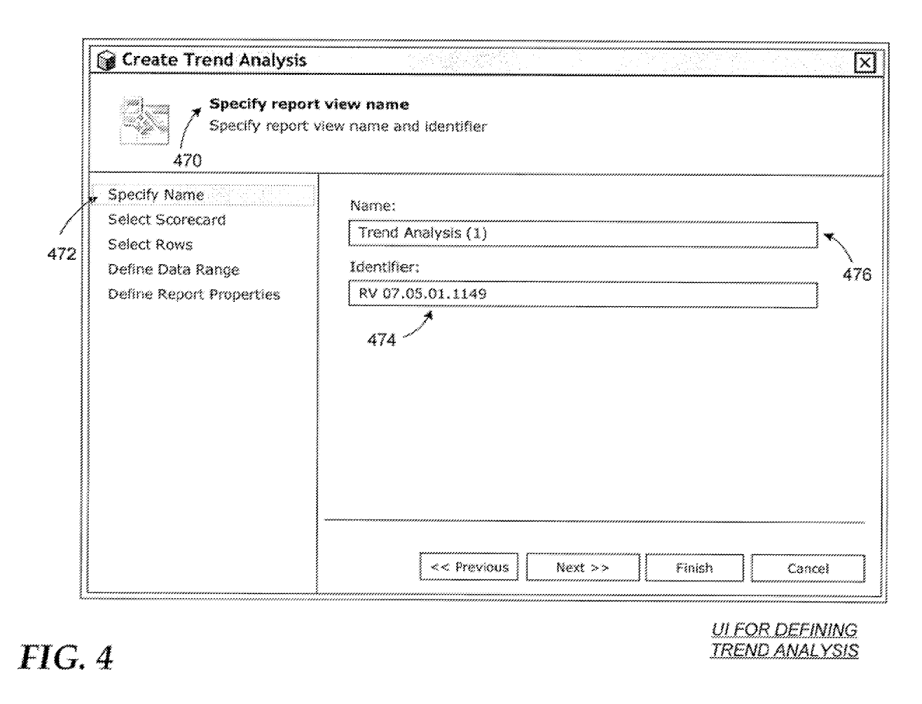

Now referring to FIG. 4, an example user interface for defining trend analysis in a scorecard application is illustrated. As one of the earlier steps in the statistical analysis process, this user interface enables the subscriber to define the analysis and assign an identifier.

The user interface includes a header 470 identifying its function (e.g. specify report view name) and a side panel 472 that lists the steps in the analysis process with the current one (“Specify Name”) highlighted. The main panel includes text boxes 476 and 474 for subscriber entry of a name for the report view of the analysis and a unique identifier, respectively. The unique identifier may be used in exchanging data and parameters associated with this particular report view with other applications and/or for security mechanisms.

The example user interface of FIG. 4, as well as the following user interfaces in subsequent figures, are for illustration purposes only and do not constitute any limitation on embodiments. Other user interfaces using different configurations such as drop-down menus, graphical (e.g. icons) approaches, and the like, may be implemented using the principles described herein.

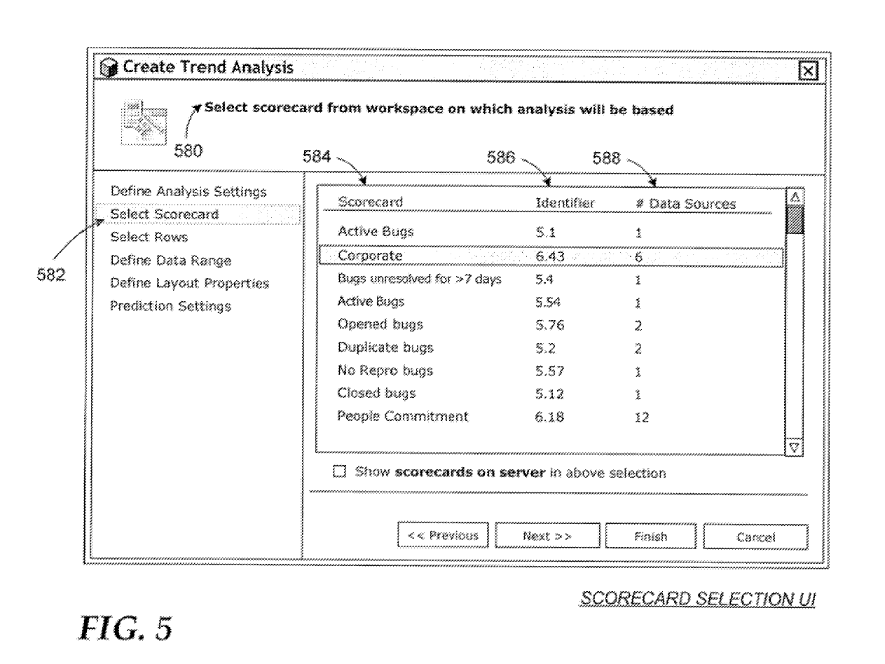

FIG. 5 illustrates an example user interface for selecting a scorecard in creating trend analysis based on performance metrics. Selecting the scorecard is another one of the early steps in the statistical analysis process. In a typical business logic application, subscribers may have access to a plurality of scorecards each having various sets of elements (metrics with different associated actuals, targets, and the like).

Moreover, each scorecard may be associated with a number of data sources, such as spreadsheets, SQL, databases, data cubes, document libraries, and the like, as described previously. Thus, the analysis may involve retrieval of data from multiple data sources. As can be expected, retrieval of data from multiple sources may sometimes result in delays due to system resource availability. Therefore, a subscriber may be given the option to limit scorecards or scorecard elements from a particular source such as a single server.

The user interface of FIG. 5 includes, similar to the user interface of FIG. 4, header 580 identifying the function of the user interface, a side panel listing the steps with current step “Select Scorecard” 582 highlighted, and a main panel listing available scorecards 584. Next to the list of available scorecards, are a list of identifiers (586) for each scorecard and a listing of the number of data sources (588) associated with each scorecard. A checkbox below the listing of scorecards enables the subscriber to limit the list to only those residing on a particular server. Other limitations such as selection of data sources, number of elements associated with each scorecard, user permissions, and the like, may also be included in the user interface.

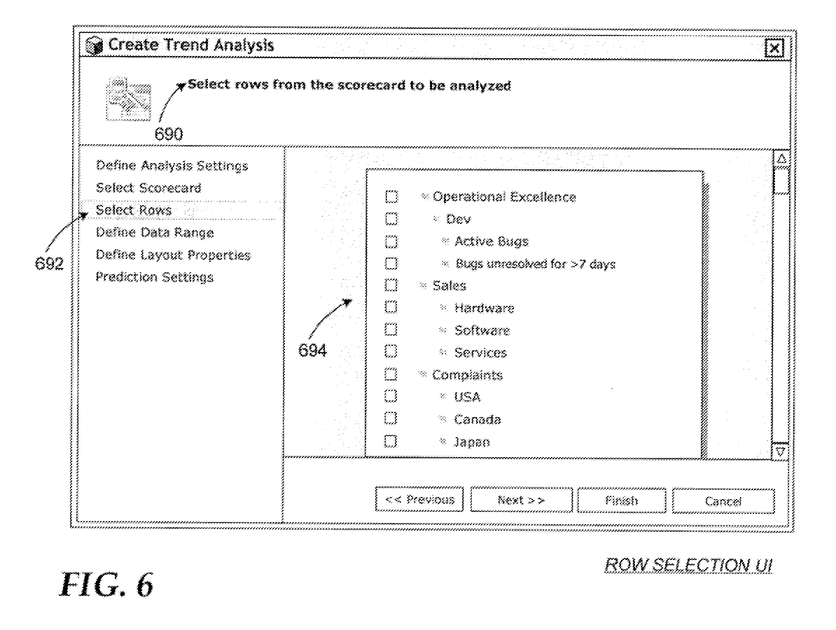

FIG. 6 is illustrates an example user interface for row selection (metric selection) as part of trend analysis in a scorecard application. The user interface of FIG. 6 also includes a header 690 identifying the function of the user interface, a side panel listing the steps with current step “Select Rows” 692 highlighted, and a main panel listing available metrics 694 for the selected scorecards.

The available rows (or metrics) 694 may be provided in many visual ways including, but not limited to, graphically organized, a listing tree pattern, simple list, and the like. Checkboxes next to each metric are one of the methods of enabling the subscriber to select rows to be included in the analysis. Other methods may include highlighting, providing links, radio buttons, and the like. According to some embodiments, each metric can be expanded to show its named sets. Selecting a row may present the subscriber with starting and ending period selections as described below.

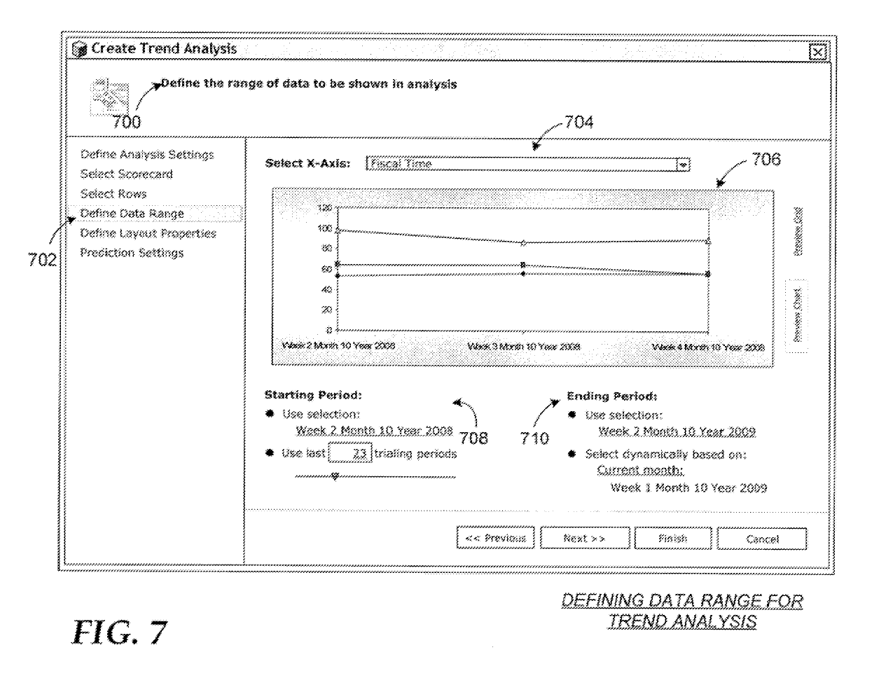

FIG. 7 illustrates an example user interface for selecting a data range as part of trend analysis in a scorecard application. Similar to the previous user interfaces, the data range selection user interface in this figure also includes header 700 describing its functionality and a side panel listing available steps with “Define Data Range” (702) highlighted.

The main panel of the user interface includes a drop-down menu selection 704 for indicating X-axis value (e.g. fiscal time in the illustrated example). Below the drop-down menu selection 704 is a previous 706 of the resulting chart displaying selected metrics along the selected X-axis dimension.

The preview 706 is followed by starting period 708 and ending period 710 selections. According to one embodiment, a subscriber may enter an explicit selection or specify a dimension relative to the ending period. If an explicit selection is entered, the subscriber may be presented with a pop-up panel that includes a level-based dimension picker based on the row selection.

According to another embodiment, starting period 708 may include a default lag of predetermined periods from the ending period 710. Ending period 710 may be specified as a selected dimension similar to Starting Period selection or by a dynamic selection. The dynamic selection may bring up a menu displaying options such as current month/quarter/year, previous day/week/month, and the like.

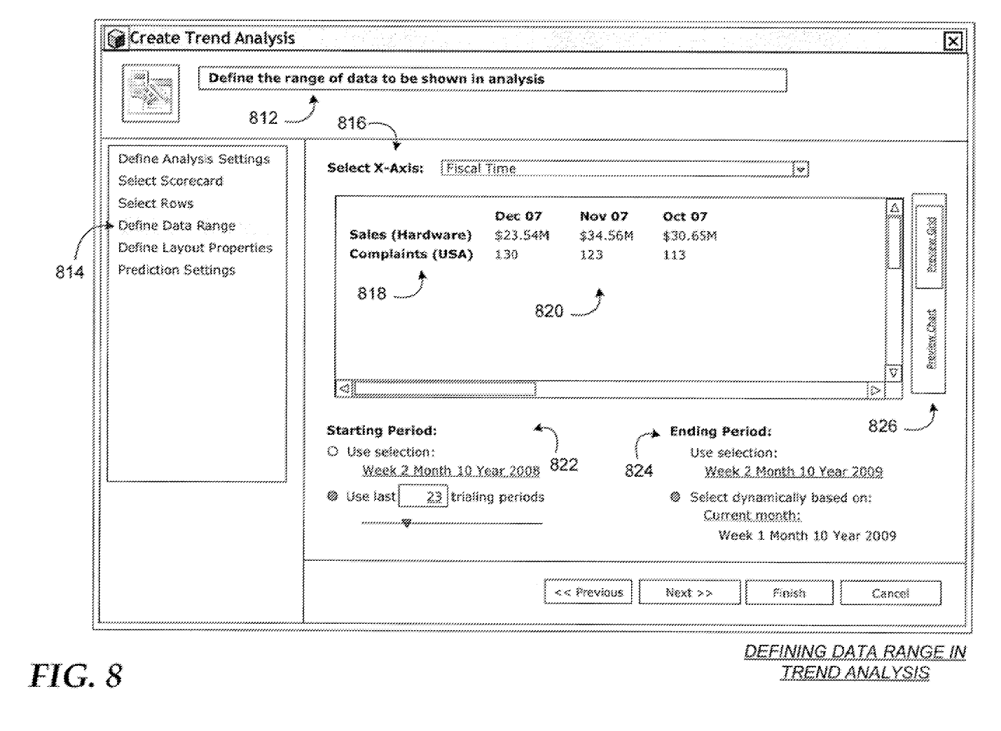

FIG. 8 illustrates another example user interface for selecting a data range as part of trend analysis in a scorecard application. The header 812 and the current selection “Define Data Range” (814) in the side panel are similar to the previous example. The “Select X-axis” drop-down menu 816, starting period 822 selection and ending period 824 selection are also similarly configured to the user interface of FIG. 7.

Differently from the user interface of FIG. 7, the preview in this case displays the scorecard grid for the selected metrics (818) (Sales and Complaints) and actuals for the selected metrics in indicated time periods 820. Next to the preview is a selection box 826 for selecting the type of preview (e.g. chart or grid). Other preview types such as a three dimensional visualization may also be included in the user interface.

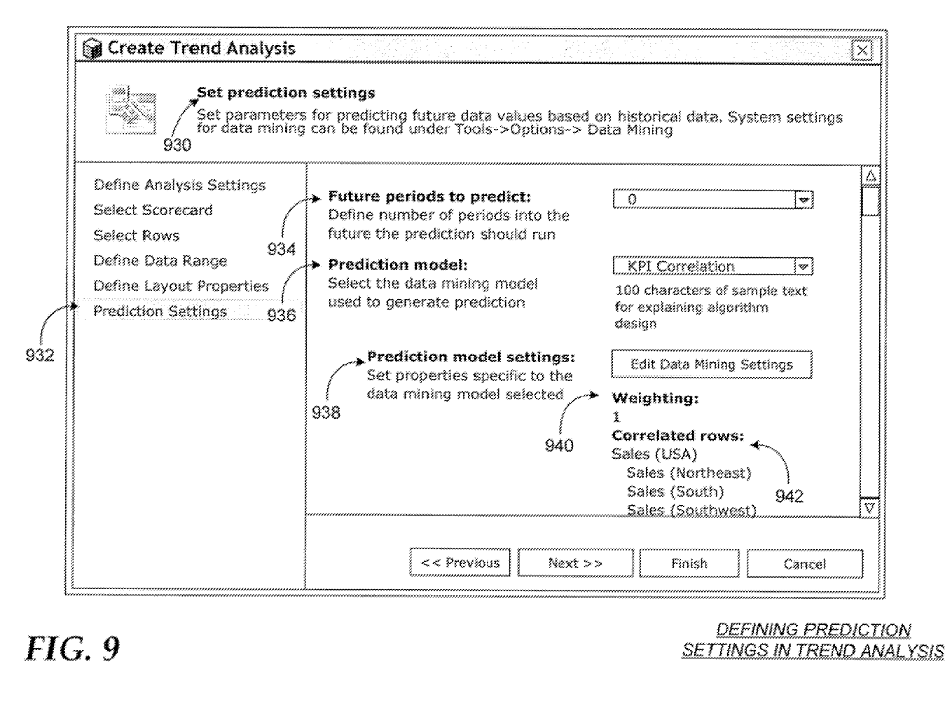

FIG. 9 illustrates an example user interface for defining prediction settings as part of trend analysis in a scorecard application. Header 930 shows the functionality of the user interface with “Prediction Settings” 932 highlighted in the side panel listing of available configuration screens (or analysis process steps).

The main panel includes “future periods to predict” 934 for the subscriber to define a number of periods into the future for which the analysis is to be run. The main panel also includes “prediction model” 936, which enables the subscriber to select a data mining model for generating the prediction. The models may include KPI correlation using neural nets, regression, and any other prediction model.

The prediction model selection is followed by “prediction model settings” 938 for enabling the subscriber to specify parameters specific to the selected analysis model. In the example user interface, weighting 940 and correlated rows 942 are the parameters presented to the subscriber for selection and/or modification based on the selected prediction model of KPI correlation.

It should be noted that while the example user interfaces present statistical analysis based on metrics of a scorecard (e.g. KPIs), statistical analysis may also be performed on underlying data (actuals, targets), scores, calculations (e.g. variations), and the like without departing from a scope and spirit of the disclosure.

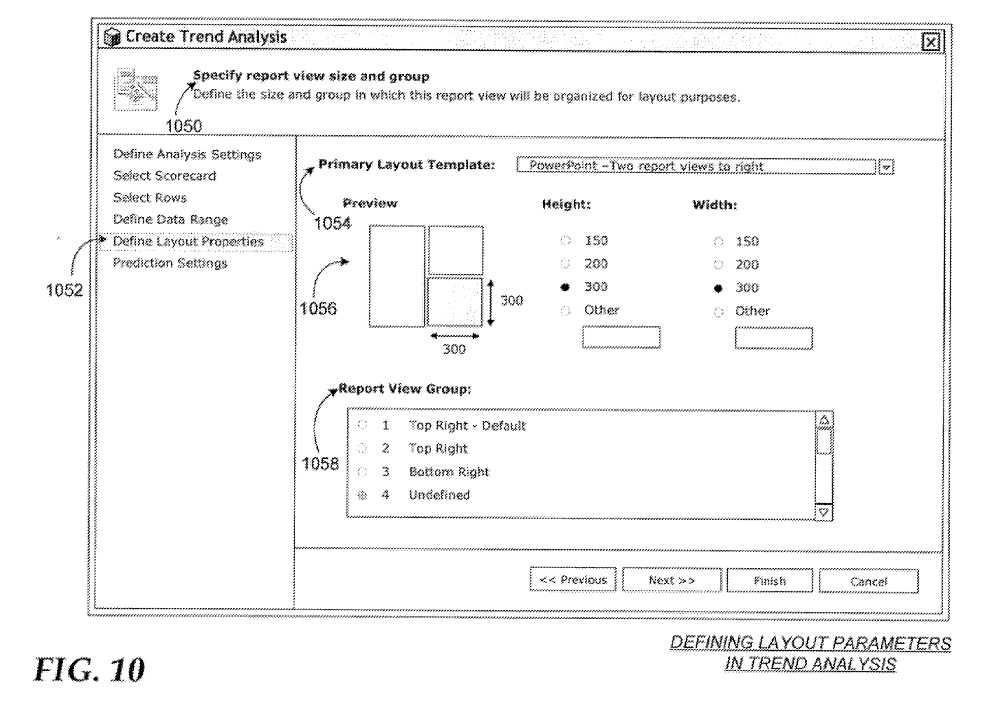

FIG. 10 illustrates an example user interface for defining layout parameters of a trend analysis report in a scorecard application. Header 1050 shows the functionality of the user interface (specifying report view size and grouping) with “Define layout properties” 1052 highlighted in the side panel listing of available configuration screens.

The main panel includes a primary layout template selection 1054. This selection may be presented as a drop-down menu as shown in the figure, as a group of icons, and the like. The available options under the selection menu may include a brief description of the layout type as well as a type of the presentation (charts, graphs, grid, image, etc.).

Next is a preview of the layout 1056 that shows the selected layout along with a selection of size options such as height and width for the report view segments. Below the preview 1056 is a grouping selection 1058 for the report view that allows each output to be grouped with others in different manners or their positioning in the main layout.

Other aspects of the report views including, but not limited to, font, font size, overall size, embellishments, text and graphic effects, and the like, may also be specified in the layout definition user interface.

Embodiments are not limited to the example user interfaces, layouts, and operations discussed above. Many other types of operations may be performed and interfaces/layouts used to implement statistical determination of multi-dimensional targets using the principles described herein.

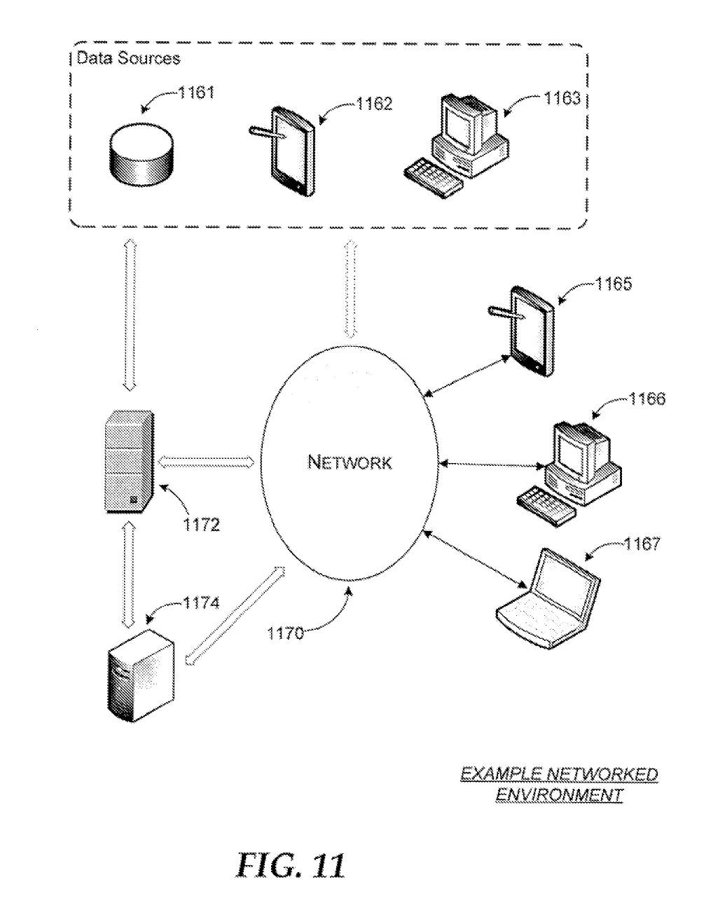

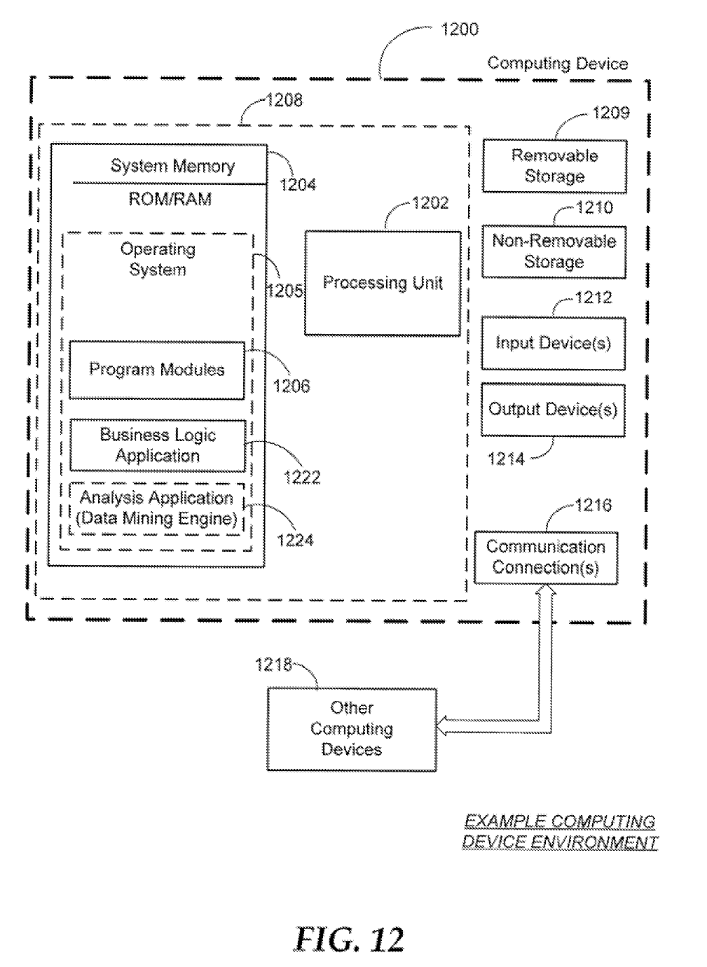

Referring now to the following figures, aspects and exemplary operating environments will be described. FIG. 11, FIG. 12, and the associated discussion are intended to provide a brief, general description of a suitable computing environment in which embodiments may be implemented.

FIG. 11 illustrates implementation of statistical determination of multi-dimensional targets in a networked system. The system may comprise any topology of servers, clients, Internet service providers, and communication media. Also, the system may have a static or dynamic topology. The term “client” may refer to a client application or a client device employed by a user to perform operations associated with statistical determination of multi-dimensional targets. While a networked business logic system may involve many more components, relevant ones are discussed in conjunction with this figure.

In a typical operation according to embodiments, business logic service may be provided centrally from server 1172 or in a distributed manner over several servers (e.g. servers 1172 and 1174) and/or client devices. Server 1172 may include implementation of a number of information systems such as performance measures, business scorecards, and exception reporting. A number of organization-specific applications including, but not limited to, financial reporting/analysis, booking, marketing analysis, customer service, and manufacturing planning applications may also be configured, deployed, and shared in the networked system.

Data sources 1161-1163 are examples of a number of data sources that may provide input to server 1172. Additional data sources may include SQL servers, databases, non multi-dimensional data sources such as text files or EXCEL® sheets, multi-dimensional data source such as data cubes, and the like.

Users may interact with server running the business logic service from client devices 1165-1167 over network 1170. In another embodiment, users may directly access the data from server 1172 and perform analysis on their own machines.

Client devices 1165-1167 or servers 1172 and 1174 may be in communications with additional client devices or additional servers over network 1170. Network 1170 may include a secure network such as an enterprise network, an unsecure network such as a wireless open network, or the Internet. Network 1170 provides communication between the nodes described herein. By way of example, and not limitation, network 1170 may include wired media such as a wired network or direct-wired connection, and wireless media such as acoustic, RF, infrared and other wireless media.

Many other configurations of computing devices, applications, data sources, data distribution and analysis systems may be employed to implement statistical determination of multi-dimensional targets. Furthermore, the networked environments discussed in FIG. 11 are for illustration purposes only. Embodiments are not limited to the example applications, modules, or processes. A networked environment for may be provided in many other ways using the principles described herein.

With reference to FIG. 12, a block diagram of an example computing operating environment is illustrated, such as computing device 1200. In a basic configuration, the computing device 1200 typically includes at least one processing unit 1202 and system memory 1204. Computing device 1200 may include a plurality of processing units that cooperate in executing programs. Depending on the exact configuration and type of computing device, the system memory 1204 may be volatile (such as RAM), non-volatile (such as ROM, flash memory, etc.) or some combination of the two. System memory 1204 typically includes an operating system 1205 suitable for controlling the operation of a networked personal computer, such as the WINDOWS® operating systems from MICROSOFT CORPORATION of Redmond, Wash. The system memory 1204 may also include one or more software applications such as program modules 1206, business logic application 1222, and analysis application 1224.

Business logic application 1222 may be any application that processes and generates scorecards and associated data. While analysis application 1224 may include any type of analysis application, such as data mining applications, it may also include other applications that generate different forms of presentations based on the scorecard data. Analysis application 1224 may be an integrated part of business logic application 1222 or operate remotely and communicate with the application and with other applications running on computing device 1200 or on other devices. Furthermore, analysis application 1224 or business logic application 1222 may be executed in an operating system other than operating system 1205. This basic configuration is illustrated in FIG. 12 by those components within dashed line 1208.

The computing device 1200 may have additional features or functionality. For example, the computing device 1200 may also include additional data storage devices (removable and/or non-removable) such as, for example, magnetic disks, optical disks, or tape. Such additional storage is illustrated in FIG. 12 by removable storage 1209 and non-removable storage 1210. Computer storage media may include volatile and nonvolatile, removable and non-removable media implemented in any method or technology for storage of information, such as computer readable instructions, data structures, program modules, or other data. System memory 1204, removable storage 1209 and non-removable storage 1210 are all examples of computer storage media. Computer storage media includes, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can be accessed by computing device 1200. Any such computer storage media may be part of device 1200. Computing device 1200 may also have input device(s) 1212 such as keyboard, mouse, pen, voice input device, touch input device, etc. Output device(s) 1214 such as a display, speakers, printer, etc. may also be included. These devices are well known in the art and need not be discussed at length here.

The computing device 1200 may also contain communication connections 1216 that allow the device to communicate with other computing devices 1218, such as over a network in a distributed computing environment, for example, an intranet or the Internet. Communication connection 1216 is one example of communication media. Communication media may typically be embodied by computer readable instructions, data structures, program modules, or other data in a modulated data signal, such as a carrier wave or other transport mechanism, and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. The term computer readable media as used herein includes both storage media and communication media.

The claimed subject matter also includes methods. These methods can be implemented in any number of ways, including the structures described in this document. One such way is by machine operations, of devices of the type described in this document.

Another optional way is for one or more of the individual operations of the methods to be performed in conjunction with one or more human operators performing some. These human operators need not be collocated with each other, but each can be only with a machine that performs a portion of the program.

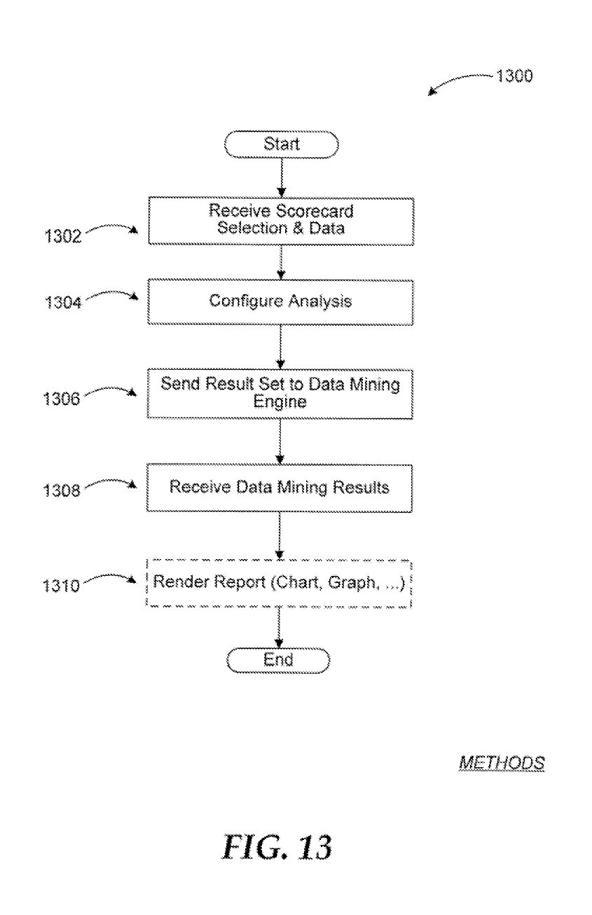

FIG. 13 illustrates a logic flow diagram for a process of statistical determination of multi-dimensional targets. Process 1300 may be implemented in a business logic application that processes and/or generates scorecards and scorecard-related reports.

Process 1300 begins with operation 1302, where a scorecard selection and data associated with the selected scorecard is received for configuration of the statistical analysis. The scorecard data may be provided by a plurality of sources such as those discussed in FIG. 1, 2, and 11. Processing advances from operation 1302 to operation 1304.

At operation 1304, different aspects of the analysis are configured based on subscriber inputs. The configurations may include metric and data range selections, analysis settings, layout parameters, and the like. According to other embodiments, the configuration parameters for the statistical analysis may include a model for data mining and a correlation specification between selected performance metrics. The model may include neural nets, regression, or Bayesian algorithm. The configuration parameters for the statistical analysis may also include resource-based settings comprising a time processing timeout and a server load balancing configuration. The statistical analysis may be performed on the scorecard data, scores, or calculations associated with the scorecard. The data range may be specified based on a dimension of the scorecard, a default level, a start and an end member, a start member and a distance, or an explicit member selection. The start and the end members may be at different levels. Furthermore, a lag period at different levels may be determined by an approximation based on child members, an explicit definition based on member attributes, or a computation based on Gregorian calendar. Processing proceeds from operation 1304 to operation 1306.

At operation 1306, the data along with the defined parameters may be sent to an analysis application such as a data mining engine. According to further embodiments, the configuration user interfaces and the data mining engine may be part of the same application or separate applications interacting on the same platform. Processing moves from operation 1306 to operation 1308.

At operation 1308, the analysis results (data mining results) are received. The results may be employed to provide a subscriber reports (charts, graphs, tables, a grid of numbers, a three dimensional visualization, etc.) based on the results: alerts such as email, instant message, and voicemail; or provide input to other applications such as workflow applications, scheduling applications, financial planning applications, and the like.

The analysis results may also be used for determining a target value associated with the performance metric. The target value may be determined by a single step process or an iterative process. For example, if an analysis is done to forecast February's sales numbers, the prediction from the first analysis and the variance of the actuals may be used as an input to the next forecast for March. This may be done iteratively, by re-running the entire process one step at a time with more and more data that is stored away. Processing advances from operation 1308 to optional operation 1310.

At optional operation 1310, one or more reports are rendered for the subscriber(s) based on the results and configurations. The reports may be rendered by the scorecard application, by the analysis application (if it is a separate application), or by a distinct presentation application. After optional operation 1310, processing moves to a calling process for further actions.

The operations included in process 1300 are for illustration purposes. Generating presentations from scorecards in a data driven manner may be implemented by similar processes with fewer or additional steps, as well as in different order of operations using the principles described herein.

The above specification, examples and data provide a complete description of the manufacture and use of the composition of the embodiments. Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims and embodiments.

What is claimed is:

1. A method to be executed at least in part in a computing device for statistically analyzing multi-dimensional performance metrics, the method comprising:
receiving a user selection of a performance metric;
receiving a user selection of a data range for the performance metric;
retrieving scorecard data based on the selected performance metric and data range;
receiving a user selection for configuration parameters associated with a statistical analysis on the scorecard data; and
performing the statistical analysis on the scorecard data based on the selected configuration parameters.

2. The method of claim 1, wherein receiving the user selection of the performance metric includes:
receiving a user selection of a scorecard;
providing a choice of available performance metrics associated with the selected scorecard; and
receiving the user selection of the performance metric.

3. The method of claim 1, further comprising determining at least one target value associated with the performance metric based on a result of the statistical analysis, wherein the target value is determined employing one of a single step process and an iterative process.

4. The method of claim 1, further comprising:
receiving a user selection for a layout configuration of a report based on a result of the statistical analysis; and
rendering the report.

5. The method of claim 4, further comprising:
providing a plurality of choices for the layout configuration selection based on a type of the statistical analysis and a type of the report.

6. The method of claim 4, wherein the scorecard data is received from at least one data source that includes one from a set of: a spreadsheet, a document library, a database, and a data cube, and wherein the report includes at least one from a set of: a chart, a graphic, a grid of numbers, and a three dimensional visualization.

7. The method of claim 1, further comprising:
providing a choice of configuration parameters for the statistical analysis that include a model for data mining and a correlation specification between selected performance metrics.

8. The method of claim 7, wherein the model includes one from a set of neural nets, regression, rules-based representation, and Bayesian algorithm.

9. The method of claim 1, wherein the configuration parameters for the statistical analysis also include resource-based settings comprising a time processing timeout and a server load balancing configuration.

10. The method of claim 1, wherein the statistical analysis is performed on at least one from a set of: the scorecard data, scores, and calculations associated with the scorecard.

11. The method of claim 1, further comprising:
providing choices for specifying the data range based on one of: a dimension of the scorecard, a default level, a start and an end member, a start member and a distance, and an explicit member selection.

12. The method of claim 11, wherein the start and the end members are at different levels.

13. The method of claim 11, wherein a lag period at different levels is determined by one of: approximation based on child members, explicit definition based on member attributes, and computation based on Gregorian calendar.

14. A system for statistically analyzing multi-dimensional performance metrics, comprising:
a memory;
a processor coupled to the memory, wherein the processor is configured to execute instructions to perform actions including:
provide a user interface for a subscriber to select among available scorecards;
in response to receiving a scorecard selection, provide a user interface for the subscriber to select among available performance metrics;
provide a user interface for the subscriber to specify a data range associated with each selected performance metric;
retrieve scorecard data based on the selected performance metrics and specified data ranges;
provide a user interface for the subscriber to specify configuration parameters associated with a statistical analysis on the retrieved scorecard data; and
perform the statistical analysis on the scorecard data based on the specified configuration parameters.

15. The system of claim 14, wherein the processor is further configured to provide the specified configuration parameters and at least a portion of the scorecard data to a data mining engine to perform at least a portion of the statistical analysis.

16. The system of claim 14, wherein the processor is further configured to configure the statistical analysis based on at least one from a set of: a subscriber-specified timeout, a default timeout, a system resource availability, and a subscriber-specified load balance configuration.

17. The system of claim 14, wherein the processor is further configured to receive a subscriber selection for a layout configuration of a report based on a result of the statistical analysis; and render the report based on the layout configuration selection, a type of the statistical analysis, and a type of the report.

18. The system of claim 14, wherein the processor is further configured to provide a result of the statistical analysis to at least one from a set of: an alerting application, a workflow application, and a scheduling application.

19. A computer-readable storage medium with instructions stored thereon for statistically analyzing multi-dimensional performance metrics, the instructions comprising:
providing a user interface for selecting among available scorecards;
in response to receiving a scorecard selection, providing a user interface for selecting among available performance metrics;
providing a user interface for specifying a data range associated with each selected performance metric;
retrieving scorecard data based on the selected performance metrics and specified data ranges;
providing a user interface for specifying configuration parameters associated with a statistical analysis on the retrieved scorecard data;
providing a user interface for specifying configuration parameters associated with a layout of a report based on a result of the statistical analysis;
performing the statistical analysis on the scorecard data based on the specified configuration parameters; and
rendering the report based on the result of the statistical analysis and the specified layout configuration parameters.

20. The computer-readable storage medium of claim 19, wherein the configuration parameters for the statistical analysis include at least one future period to predict.
